(19) United States
(12) Patent Application Publication
(10) Pub. No.: US 2013/0252187 A1
(43) Pub. Date: Sep. 26, 2013

(54) Layer Candle and the Method of Layer Candle Manufacturing

(71) Applicants: Andrzej Wróbel, Wielun (PL); Jaroslaw Wolowiec, Wierzchlas (PL); Monika Zawadzka, Mokrsko (PL)

(72) Inventors: Andrzej Wróbel, Wielun (PL); Jaroslaw Wolowiec, Wierzchlas (PL); Monika Zawadzka, Mokrsko (PL)

(73) Assignee: KORONA SA, Wielun (PL)

(21) Appl. No.: 13/642,647

(22) PCT Filed: Apr. 21, 2011
(86) PCT No.: PCT/PL2011/050009

§ 371 Date: Jun. 3, 2013

(30) Foreign Application Priority Data
Apr. 21, 2010 (PL) 391031

(51) Int. Cl. C11C 5/00

(52) U.S. Cl. CPC C11C 5/008
USPC 431/288; 264/241

(57) ABSTRACT

Layer candle made of the granulated product is provided with the outer hardened layer (1), and the candle inside is filled with the loose granulated product. The method of layer candle manufacturing consists in the preliminary heating of the outer layer of the candle and its further forming in the process of pressing.

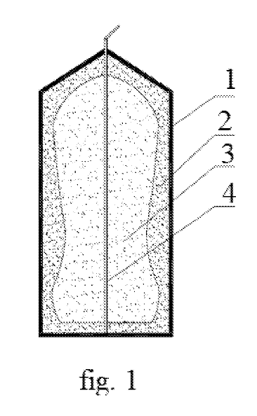

The subject-matter of the invention is a candle provided with a combustible material formed of layers as well as the method of such layer candle manufacturing.

Candles with a layer structure which have been known until now, have been provided with outer shells, spread in a permanent way on the candle surface by painting it by hand, by spraying or dipping, which mainly contributed to an aesthetic effect of the candle. Shells in a form of paint, lacquer or plastics are subjected to damage along with the progress of burning out of the candle. According to the patent application Nr 379202, the candle is known having an outer layer spread permanently on its surface. Such candles are made of standard combustible materials, including granulated products. Candles having been manufactured until now, are being produced basing on the traditional method of pressing, which consists in joining paraffin granulated products subjected to pressure in the moulds intended for this purpose, by means of hydraulic servo-motor or mechanical punch. Under pressure, paraffin granules are crushed and as a result—the candle is being formed depending on the said mould construction. Process of forming is carried out under pressure of 7-10 tons.

The side effect of this process is uncontrolled rise of temperature, having a negative impact both on the whole process and the final product itself The candle manufactured basing on this method is tightly packed, and because of that—it is heavy and material-consuming. The discussed, known method of candles pressing, limits possibilities of application of mixtures with a high content of ecological raw-materials.

The layer candle made of the granulated product according to the invention is provided with a hard layer, next—a slightly thickened layer, and a loose layer.

The method according to the invention consists in that the mould before introduction of the granulated product is heated to the temperature from 30 up to 75° C., and after plasticization of the granulated products adherent to the walls of the mould, the process of pressing under pressure from 0.1 up to 2 tons is being conducted.

The candle according to the invention is lighter than candles made of the uniform granulated product, and due to that—less raw-material is needed for its making with the simultaneous meeting of qualitative parameters of the product. The method according to the invention makes it is possible to apply even 100% of natural raw-material which is fully renewable. A positive effect of application of the method according to the invention is reduction of energy consumption by reduction of pressure during pressing.

The subject-matter of the invention in the example of making is presented in the attached figure showing its longitudinal section.

The example of invention introduction: In the method according to the invention, the granulated product was applied, which was composed of the mixture with a high content of the renewable raw-material. The mould before introduction of the granulated product is heated up to the temperature of 35° C. The function of the heated mould is to slightly plasticize the granulated product situated adherently to the walls of the mould. After plasticization of the granulated product, pressing under pressure of 0.2 ton is being conducted, which is considerably lower than the pressure according to the method having been applied until now. Respectively, the process of joining of the plasticized granules, is taking place. After leaving the mould, the candle has a hardened surface which is 0.2-0.3 mm thick and enables meeting the highest qualitative standards by the candle weighting 5-30% less than any candle produced basing on the traditional method. In its inside, the candle remains in a form of the granulated product. The layer candle according to the invention has the hard outer layer (1), having a form of melted and pressed granulated product. Next there is the slightly thickened layer (2) formed of the slightly thickened granulated product. The candle inside is the loose layer (3) composed of the loose granulated product. Inside the candle there is the candle wick (4).

1. The layer candle made of the granulated product, provided with a wick and characterized in that it possesses the hard layer (1), next—the slightly thickened layer (2) and the loose layer (3).

2. The method of layer candle manufacturing with the application of the method based on of the granulated product pressing conducted in the mould and characterized in that the mould before introduction of the granulated product is heated to the temperature from 30 up to 75° C., and that after plasticization of the granulated product adjacent to the walls of the mould—the process of pressing under pressure from 0.1 up to 2 tons is being conducted.
